(19) United States
(12) Patent Application Publication
(10) Pub. No.: US 2024/0367803 A1
(43) Pub. Date: Nov. 7, 2024

(54) MOISTURE ICING DETECTION SYSTEM AND METHOD

(71) Applicant: Pegasus Imagery Ltd., Sturgeon County (CA)

(72) Inventors: Mark Timothy Alexander NESDOLY, Sturgeon County (CA); Akaljot Singh GILL, Sturgeon County (CA); Joshua Cale RICHARD, Sturgeon County (CA); William Cole ROSENTRETER, Sturgeon County (CA); Michael DOCKERY, Sturgeon County (CA); Mark SHERSTAN, Sturgeon County (CA)

(21) Appl. No.: 18/247,971

(22) PCT Filed: Aug. 5, 2022
(86) PCT No.: PCT/CA2022/051202

§ 371 Date: Apr. 5, 2023

Related U.S. Application Data
(60) Provisional application No. 63/261,977, filed on Oct. 1, 2021.

(51) Int. Cl. B64D 15/20; G01K 3/00; G01N 27/22

(52) U.S. Cl. CPC B64D 15/20; G01K 3/005; G01N 27/223

(57) ABSTRACT

Methods and systems are described for a moisture and icing detection system for an aircraft with an exterior component. The moisture and icing detection system includes a flexible sensor film comprising a water sensor and temperature sensor for application to an exterior surface of the exterior component. The moisture and icing detection system also includes a sensor head in electric communication with water sensor and temperature sensor of the flexible sensor film that generates an icing condition warning if the water sensor indicates the presence of water or ice on the flight surface and the temperature sensor indicates temperatures less than the freezing temperature of water. The icing condition warning may then be acted upon through a control action initiated by the moisture and icing and detection system.

### CROSS-REFERENCE TO RELATED APPLICATIONS

This application claims priority to and benefit of U.S. Provisional Patent Application No. 63/261,977 filed Oct. 1, 2021, the contents of which are incorporated by reference.

### TECHNICAL FIELD

The present disclosure generally relates to detecting the icing of moisture on aircraft, particularly on wings, rotors and other aircraft components.

### BACKGROUND

Aircraft are at risk if flight components, such as flight surfaces or engine intakes, are affected by ice buildup. Ice on the flight surface can change the flight characteristics, reducing lift and in some cases can cause the aircraft to crash. Ice in an engine intake can cause the engine to stall, with potentially catastrophic results.

Ice can form on aircraft components due to moisture in the atmosphere and cool temperatures. If the flight surfaces are a different temperature than the surrounding atmosphere, water vapor may condense onto the surface and subsequently freeze, forming ice.

Early detection of ice buildup can be crucial to taking steps to remove or reduce the ice or, alternatively, to abort a flight. It is therefore desirable to have systems and methods for detection of ice on aircraft components.

### SUMMARY

In various examples, the present disclosure describes systems and methods of a moisture and icing detection system for an aircraft with an exterior component. The moisture and icing detection system includes a flexible sensor film comprising a water sensor and temperature sensor for application to an exterior surface of the exterior component. The moisture and icing detection system also includes a sensor head in electric communication with water sensor and temperature sensor of the flexible sensor film that generates an icing condition warning if the water sensor indicates the presence of water or ice on the flight surface and the temperature sensor indicates temperatures less than the freezing temperature of water. The icing condition warning may then be acted upon through a control action initiated by the moisture and icing detection system.

In some aspects, the present disclosure describes an icing warning system for a structure with an exterior surface. The system comprises: a flexible sensor film comprising a water sensor for application to the exterior surface; a temperature sensor for measuring the exterior temperature proximate to the exterior surface; a sensor head in electric communication with the water sensor and the temperature sensor, that receives raw data from the water sensor and temperature sensor; and a controller in communication with the sensor head that generates an icing warning if the raw data received from the sensor head includes that the water sensor indicates the presence of water or ice on the exterior surface and the temperature sensor indicates temperatures less than the freezing temperature of water.

In an example of the preceding example aspect of the system, flexible sensor film is a flexible printed circuit board.

In an example of any one of the preceding example aspects of the system, the sensor head in electrical communication with the water sensor and temperature sensor comprises a web of flexible printed circuit board.

In an example of any one of the preceding example aspects of the system, the exterior surface is a flight surface of a manned or unmanned aircraft.

In an example of any one of the preceding example aspects of the system, the temperature sensor is on the sensor film.

In an example of any one of the preceding example aspects of the system, the controller is contained within the sensor head.

In an example of any one of the preceding example aspects of the system, further comprising a communication link between the controller and an operator warning system, wherein the generated icing warning comprises an electrical communication to the operator warning system.

In an example of any one of the preceding example aspects of the system, further comprising a user interface on a mobile communication device in communication with the controller.

In an example of any one of the preceding example aspects of the system, the water sensor comprises a electronic capacitive detector.

In an example of any one of the preceding example aspects of the system, further comprising the sensor head generating water presence and temperature information.

In an example of any one of the preceding example aspects of the system, the sensor head is in wireless communication with the water sensor and temperature sensor.

In an example of the preceding example aspect of the system, the wireless communication includes a radiofrequency (RF) identification (ID) tag in the flexible sensor film and a RF reader in the sensor head.

In an example of some of the preceding example aspects of the system, the exterior surface is a propeller of the manned or unmanned aircraft.

In an example of some of the preceding example aspects of the system, the exterior surface is an air intake for an engine of the manned or unmanned aircraft.

In an example of some of the preceding example aspects of the system, the exterior surface is an exterior surface of an ingress protection (IP) rated enclosure.

In an example aspect, the present disclosure describes an icing warning method. The method comprises a number of steps. Raw data from a water sensor and a temperature sensor on a surface is received at a sensor head, the water sensor and temperature sensor being situated on a sensor film. The presence of ice or the potential for ice on the surface is determined based on the raw data from the water sensor and the temperature sensor and the determination of the presence of ice or the potential for ice is communicated to a human operator and/or other systems.

In some examples of the method, the surface is an exterior surface of a manned or unmanned aircraft.

In some examples of the method, receiving raw sensor data is done at the sensor head using an electrical communication with the sensor film comprising the water sensor and the temperature sensor.

In some examples of the method, communicating the determination comprises initiating a warning system when there is a determination of icing or the potential for icing.

In some examples of the method, communicating the determination of the presence of ice or the potential for ice to a human operator and/or other systems comprises communicating the presence of ice or the potential for ice to a de-icing system.

In some examples, the method further comprises initiating a de-icing action by the de-icing system, based on the communication of the determination of the presence of ice or the potential for ice.

In some examples of the method, the exterior surface is a propeller of the manned or unmanned aircraft.

In some examples of the method, the exterior surface is an air intake for an engine of the manned or unmanned aircraft.

In some examples of the method, the exterior surface is an exterior surface of an ingress protection (IP) rated enclosure.

In some examples of the method, determining the presence of ice or the potential for ice on the surface further comprises a lookup table using the raw data from the water sensor and the temperature sensor.

In some examples of the method, determining the presence of ice or the potential for ice on the surface further comprises computing, using a trained machine learning (ML) model, the presence of ice or the potential for ice on the surface, based on the raw data from the water sensor and the temperature sensor.

In some examples, the method further comprises training an ML model to provide the trained ML model. Training the ML model comprises: acquiring icing wind tunnel testing data samples including: a measured water sensor data sample on the surface; a measured temperature sensor data sample on the surface; and a measured ice thickness data sample on the surface; and training the ML model based on the wind tunnel testing data samples.

In some examples of the method, determining the presence of ice or the potential for ice on the surface further comprises obtaining humidity data and an installation adjustment and the determination of the presence of ice or the potential for ice further includes the humidity data and the installation adjustment.

In some examples of the method, determining the presence of ice or the potential for ice on the surface further comprises obtaining ultrasound data and the determination of the presence of ice or the potential for ice further includes the ultrasound data.

In another example aspect, the present disclosure describes a non-transitory computer readable medium having instructions encoded thereon. The instructions, when executed by one or more processor devices, cause the processor to perform any one of the preceding example aspects of the method.

### BRIEF DESCRIPTION OF THE DRAWINGS

Reference will now be made, by way of example, to the accompanying drawings which show example embodiments of the present application, and in which:

FIG. 1 is a block diagram of an example computing system which may be used to implement examples of the present disclosure.

FIG. 2 is a schematic diagram illustrating an example moisture and icing detection system, in accordance with examples of the present disclosure.

FIG. 3 is an exploded schematic diagram of example hardware components of the moisture and icing detection system, in accordance with examples of the present disclosure.

FIG. 4 is a block diagram of an example sensor head of the moisture and icing detection system, in accordance with examples of the present disclosure.

FIG. 5 is a top view of a sensor film, in accordance with examples of the present disclosure.

FIG. 6A is a perspective view of an example embodiment of a sensor film configured on a flight surface, in accordance with examples of the present disclosure.

FIG. 6B is a perspective view of the embodiment of FIG. 6A, in accordance with examples of the present disclosure.

FIG. 6C is a perspective view of the embodiment of FIG. 6A, in accordance with examples of the present disclosure

FIG. 7A is a top view of an example embodiment of a sensor film configured on a flight surface, and where the sensor head is interior to the flight surface, in accordance with examples of the present disclosure.

FIG. 7B is a perspective view of the embodiment of FIG. 7A, in accordance with examples of the present disclosure.

FIG. 8A is an example embodiment of a sensor film configured on a flight surface, where the sensor film is installed on a leading edge of an engine air intake, in accordance with examples of the present disclosure.

FIG. 8B a close-up view of the embodiment of FIG. 8A, in accordance with examples of the present disclosure

FIG. 9 is a flowchart illustrating example operations of a moisture and icing detection method, in accordance with examples of the present disclosure.

Similar reference numerals may have been used in different figures to denote similar components.

### DETAILED DESCRIPTION

The following describes example technical solutions of this disclosure with reference to accompanying figures. Similar reference numerals may have been used in different figures to denote similar components.

In various examples, the present disclosure describes systems and methods of a moisture and icing detection system for an aircraft with an exterior component. The moisture and icing detection system includes a flexible sensor film comprising a water sensor and temperature sensor for application to an exterior surface of the exterior component. The moisture and icing detection system also includes a sensor head in electric communication with the water sensor and the temperature sensor of the flexible sensor film, that generates an icing condition warning if the water sensor indicates the presence of water or ice on the flight surface and the temperature sensor indicates temperatures less than the freezing temperature of water. The icing condition warning may then be acted upon through a control action initiated by the moisture and icing detection system.

To assist in understanding the present disclosure, the following describes some concepts relevant to icing detection and warning systems, along with some relevant terminology that may be related to examples disclosed herein.

In the present disclosure, a “flight surface” can mean: a wing, a tail, stabilizer, engine intake, helicopter rotor blade or any surface related to flight of an airborne vehicle. In examples, an airborne vehicle may be manned, or unmanned.

In the present disclosure, “ice type” can mean: a reference to whether ice accumulating on a flight surface is clear ice (e.g., a heavy coating of clear, smooth ice which forms on flight surfaces when flying in areas with high concentration of large supercooled water droplets or freezing rain, and where the supercooled water droplets do not freeze on contact with the flight surface), rime ice (e.g., a coating of rough, opaque ice which forms on flight surfaces when supercooled drops rapidly freeze on contact and conforming to the shape of the flight surface), mixed ice (e.g., a combination of clear and rime ice, having properties of both ice types), frost ice (e.g. water freezing on flight surfaces while the aircraft is stationary prior to flight).

In the present disclosure, “ice accretion” or “ice accumulation” can mean: The process by which layers of ice build-up on the surface of an object when it is exposed to freezing or supercooled precipitation. In some contexts, “ice accumulation” may refer to a total amount of accumulated ice on a surface, whereas “ice accretion” may refer to the process by which, or the rate at which, ice accretes or accumulates on a surface.

In the present disclosure, “icing condition” or “icing event” can mean: The presence of ice that has formed on a surface, for example, on a flight surface or another exterior surface.

In the present disclosure, an “icing condition prediction” can mean: A probability or likelihood that an icing condition has occurred or will occur on a surface, or an estimate of the potential for ice to form on a surface obtained from a model. An icing condition prediction may be determined from the model based on inputs, the inputs being raw data samples received from sensors of the moisture and icing detection system, such as a water sensor and a temperature sensor. In examples, the icing condition prediction may include a classification, in which the prediction data may include a predicted class, or a probability distribution over one or more classes, for each data sample, or for portions of each data sample, received as input.

In the present disclosure, a “model” refers to a probabilistic, mathematical, or computational model used to process input data to generate prediction information regarding the input data. In the context of machine learning, a “model” refers to a model trained using machine learning techniques, for example, machine learning configured as an artificial neural network or another network structure.

In the present disclosure, a “data sample” can mean: a single instance of data in a particular format. A single data sample may be provided to a model as input data. In some examples, a model may generate a data sample as output data. Examples of a single data sample include a moisture measurement obtained from a water sensor or a temperature measurement obtained from a temperature sensor.

In the present disclosure, an “icing condition warning” can mean: A notification or an alert provided to a user to communicate the risk of an icing condition occurring, based on an icing condition prediction. In examples, an icing condition warning may be communicated to a user by a display of a mobile communication device, such as a tablet, or an icing condition warning may be communicated to a user using another system.

In the present disclosure, an “icing warning system” can mean: A system that generates an icing condition warning and communicates the icing condition warning to a user or to another device or logical process. In examples, the moisture and icing detection system of the present disclosure may be an icing warning system.

In the present disclosure, a “de-icing system” can mean: A system for removing ice from a surface after ice has formed and/or accumulated on the surface, or preventing ice from forming or accumulating on a surface through active measures. Examples of de-icing systems include: a chemical de-icing system, for example, where ice is removed from a surface or prevented from forming thereon by applying a de-icing fluid or another chemical to the surface; an electrical de-icing system, for example, where ice is removed from a surface or prevented from forming thereon by thermoelectric elements; or a mechanical de-icing system, for example, where ice is removed from a surface or prevented from forming thereon by a mechanical action.

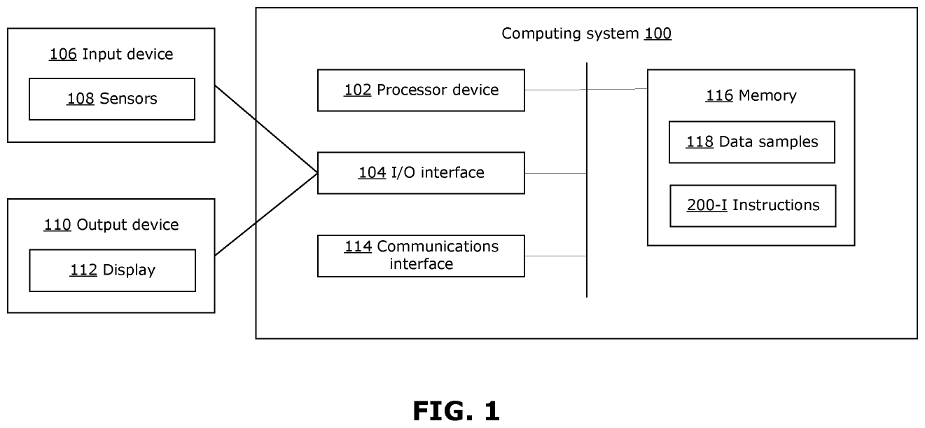

In the present disclosure, a “control action” can mean: an action performed by a computing device or computer application. In the present disclosure, a “de-icing action” can mean: a control action associated with a de-icing system, for example, a control action taken by a computing system of a de-icing system in response to an instruction. For example, a de-icing action associated with a chemical de-icing system may cause the computing device or computer application that controls the chemical de-icing system to apply a de-icing fluid to an iced surface. FIG. 1 shows a block diagram of an example hardware structure of a computing system 100 that is suitable for implementing embodiments of the system and methods of the present disclosure, described herein. Examples of embodiments of the system and methods of the present disclosure may be implemented in other computing systems, which may include components different from those discussed below. The computing system 100 may be used to execute instructions to carry out examples of the methods described in the present disclosure. The computing system 100 may also be used to train the machine learning models of the moisture and icing detection system 200, or the moisture and icing detection system 200 may be trained by another computing system.

Although FIG. 1 shows a single instance of each component, there may be multiple instances of each component in the computing system 100.

The computing system 100 includes at least one processor device 102, such as a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof.

The computing system 100 may include an input/output (I/O) interface 104, which may enable interfacing with an input device 106 (for example, sensors 108) and/or an output device 110 (for example, a display 112). The sensor(s) 108 may include a water/moisture sensor 215, a temperature sensor 220, or optionally a humidity sensor 240, a vibration sensor 242, an accelerometer 244 or a gyroscope, an ambient temperature sensor 246 or an ultrasound sensor 248 or an optical sensor, among other possibilities. Sensor data may be sampled continuously or at particular time steps. The computing system 100 may include or may couple to other input devices (e.g., a keyboard, a mouse, a camera, a touchscreen, and/or a keypad etc.) and other output devices (e.g., a speaker and/or a printer etc.).

The I/O interface 104 may buffer the data generated by the input device 106 and provide the data to the processor device 102 to be processed in real-time or near real-time (e.g., within 10 ms, or within 100 ms). The I/O interface 104 may perform preprocessing operations on the input data, for example normalization, filtering, denoising, etc., prior to providing the data to the processing unit 102.

The I/O interface 104 may also translate control signals from the processor device 102 into output signals suitable to each respective output device 110. The display 112 may receive signals to provide a visual output to a user. The output device may be any mobile or stationary electronic device such as a mobile communication device (e.g., smartphone), a tablet device, a laptop device, a network-enabled vehicle (e.g., a vehicle having an electronic communication device integrated therein), a wearable device (e.g., smartwatch, smart glasses, etc.), a desktop device, an internet of things (IoT) device, among others.

The computing system 100 includes at least one communications interface 114 for wired or wireless communication with a network (e.g., an intranet, the Internet, a P2P network, a WAN and/or a LAN) or other node. The network interface 106 may include wired links (e.g., Ethernet cable) and/or wireless links (e.g., one or more antennas, RFID tags) for intra-network and/or inter-network communications. For example, the communication interface 114 may include any suitable structure for generating signals for wireless or wired transmission and/or processing signals received wirelessly or by wire. The controller 100 may also interface with other systems, for example, a de-icing system, for executing control actions 290, for example, activating a de-icing system.

The controller 100 includes at least one memory 116. The memory 116 stores instructions and data used, generated, or collected by the controller 100, for example, data samples 118 obtained by sensors 108. The memory 116 may store software instructions or modules configured to implement some or all of the functionality and/or embodiments described herein and that are executed by the processor device 102. For example, the memory 116 may include instructions 200-I for executing the moisture and icing detection system 200. Each memory 116 may include any suitable volatile and/or non-volatile storage and retrieval device(s). Any suitable type of non-transitory memory may be used, such as random access memory (RAM), read only memory (ROM), hard disk, optical disc, subscriber identity module (SIM) card, memory stick, secure digital (SD) memory card, and the like.

In some examples, the computing system 100 may also include one or more electronic storage units (not shown), such as a solid state drive, a hard disk drive, a magnetic disk drive and/or an optical disk drive. In some examples, one or more data sets and/or modules may be provided by an external memory (e.g., an external drive in wired or wireless communication with the controller 100) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. The components of the computing system 100 may communicate with each other via a bus, for example.

Although illustrated as a single block, the computing system 110 may be implemented as a single physical machine (e.g., implemented as a single computing device, such as a single workstation, single server, etc.), or may be implemented using a plurality of physical machines (e.g., implemented as a server cluster). For example, the computing system 110 may be implemented as a virtual machine or a cloud-based service (e.g., implemented using a cloud computing platform providing a virtualized pool of computing resources).

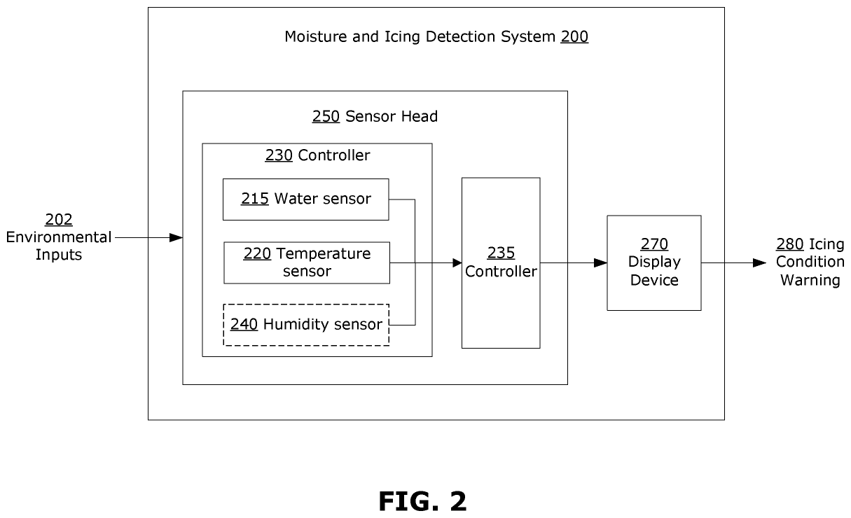

FIG. 2 shows a block diagram of an example moisture and icing detection system 200 of the present disclosure. The moisture and icing detection system 200 may be a software that is implemented in the computing system 100 of FIG. 1, in which the processor device 102 is configured to execute instructions 200-I of the moisture and icing detection system 200 stored in the memory 116.

In examples, the moisture and icing detection system 200 receives environmental inputs 202 and outputs an icing condition warning 280 on a display device 270. The moisture and icing detection system 200 may contain one or more controllers (e.g. controllers 230 and 235) within the sensor head 250, such as one or more microprocessors running software and memory for storing data and the software. Further details of the operation of sensor head 250 are described with reference to FIG. 2B. In examples, controller 230 may operate one or more sensors 108 to obtain the environmental inputs 202, such as a water sensor 215, a temperature sensor 220 and optionally a humidity sensor 240 or an ultrasound sensor 248 (not shown), among other sensors. In an embodiment, for example, an ultrasound sensor 248 or optionally, an optical sensor or a laser device may be used for measuring ice dimensions (e.g. ice thickness) on the surface.

In some embodiments, for example, either controller 230 or 235 may be implemented using computing system 100, or in other examples, controller 230 may simply be a processor device 102 and communications interface 114 or an I/O interface 104 (for example, for communicating with controller 235), or a memory 116.

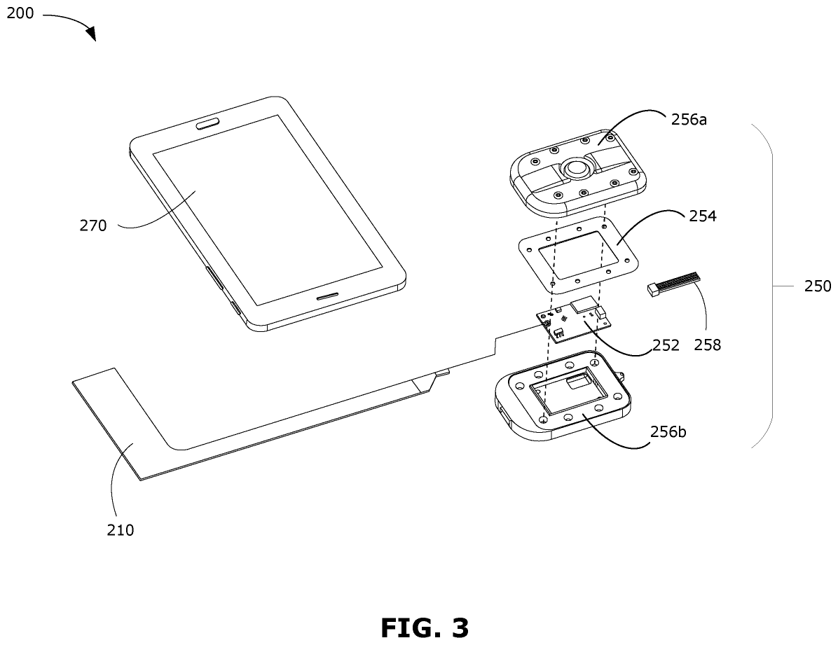

FIG. 3 is an exploded schematic diagram of example hardware components of the moisture and icing detection system 200, in accordance with examples of the present disclosure. In examples, the moisture and icing detection system 200 includes a sensor film 210, a sensor head 250 and a unit for interfacing with a human operator, for example, a display 270. In some embodiments, for example, the sensor film 210 may be formed from flexible electrical circuit material or flexible printed circuit board (PCB 252) and may include a water sensor 215 and a temperature sensor 220. The sensor film 210 may be in electronic communication with the sensor head 250.

In some embodiments, for example, the sensor head 250 may include a PCB 252 secured within a housing 254 inside an enclosure formed of an upper enclosure 256a and a lower enclosure 256b. In examples, the enclosure for the sensor head 250 may be an ingress protection (IP) enclosure. The sensor head 250 may be powered via cable 258. In examples, the sensor head 250 may be powered by a battery or by solar panels, or power to the sensor head 250 may be provided by direct line from the aircraft power system. In examples, the housing of the sensor head 250 may be fabricated of any material.

In some embodiments, for example, the display 270 may be an electronic device with a display, for example, a tablet device in electronic communication with the sensor head. In examples, the display 270 may be used to implement a user interface or to interface with controller 235 of the moisture and icing detection system 200. In some embodiments, for example, another device may communicate with one or more controllers of the sensor head 250, for example, a computer system in an aircraft cockpit or in a hangar, etc. In some embodiments, for example, the display 270 may be portable and may be used inside the aircraft, or outside of the aircraft when a user is on the ground. In some embodiments, the display 270 may implement the features of controller 235 described herein, and may communicate with the controller 30 housed within the sensor head 250 over a network interface 114.

The sensor film 210 may comprise a panel shape such as a rectangle, square, circular, or similar shape, or may be irregular (for example, an “L” shape) to fit an exterior surface of a component, such as a flight surface. In application, the sensor film 210 may be applied to a flight surface, such as wing, tail, stabilizer, engine intake or helicopter rotor blade, such as on the leading edge. The sensor film 210 may not cover the entire surface but may cover one or more areas of interest. In some embodiments, for example, the sensor film 210 may be approximately four square inches.

The flexibility of the circuit material of the sensor film 210 may allow the sensor film 210 to be applied over curved surfaces, such as the leading edge of the flight surface. The sensor film 210 is preferably thin, such as 0.1 mm (0.004″) thick. The sensor film 210 is preferably thin enough to not materially affect the characteristics of the surface such as when affixed to a flight surface. The thinness of the sensor film may also aid in its flexibility and therefore closely follow the surface.

The sensor film 210 may be affixed to the surface using adhesive, glue or other means to firmly attaching the sensor film 210 to the surface so it is not dislodged, such as during flight. The sensor film 210 may be painted to match the surface such as part of finishing or maintaining the flight surface. The sensor film 210 may be affixed to portions of the flight surface that are conductive or non-conductive.

In examples, the sensor film 210 may include a water sensor 215 comprising two or more electrical terminals, such as interdigitation ‘fingers’, such that electronic capacitance between at least two of the terminals may indicate the presence of water. For example, when water or ice is present, the capacitance measured by the sensor changes. The presence of water or ice results in an increase in the capacitance. The sensor film 210 may further comprise a solid state temperature sensor 220 that can detect the temperature of the sensor film 210. The temperature sensor 220 may be in close proximity to water sensor 215 so that the temperature sensor 220 approximates the temperature of any water or ice. If the temperature detected by the temperature sensor 220 is at or less than the freezing temperature of water, an inference may be made that ice is or may form on the flight surface. The temperature sensor 220 can therefore assist with distinguishing rain or fog when the temperature is higher, and potential icing conditions when the temperature is lower. The temperature sensor 220 is preferably insulated from the sensor head 250 or other components of the aircraft which may result incorrect temperature values or slow the response of the temperature sensor 220. The temperature sensor 220 may in some examples be used to detect a surface temperature and may be referred to as a surface temperature sensor 220 in some contexts, to distinguish it from an ambient temperature sensor 246, used to detect air temperature, as described further below.

The sensor film 210 is connected and in electric communication with a sensor head 250. The water sensor 215 and any temperature sensor 220 in the sensor film 210 may be controlled by or in communication with the sensor head 250. In embodiments, more than one sensor film 210 may be connected to a single sensor head 250. In this way, a plurality of water sensors 215 and temperature sensors 220 may be placed on more than one aircraft component or surface proximate to the sensor head 250 without requiring more than one sensor head 250.

In some embodiments, for example, the sensor film 210 may be integrated with the sensor head 250. The sensor film 210 may be connected with the sensor head 250 using one or more filaments, wires, webs or other electrically connective means. The sensor head 250 may be in close proximity with the sensor film 210 such as on the exterior of the aircraft near the flight surface on which the sensor film 210 is affixed, or inside the aircraft such as in an access panel. In some embodiments, for example, the sensor head 250 may contain an ambient temperature sensor 246, particularly if the temperature sensor 220 is not contained in the sensor film 210. In some embodiments, both a surface temperature sensor 220 (in the sensor film 210) and an ambient temperature sensor 246 (e.g., in the sensor head 250) may be used in conjunction to detect various conditions presenting a high likelihood of an icing condition manifesting, as described further below.

In other embodiments, a sensor film 210 may be replaced by a custom body panel or access panel on the surface. In another embodiment, the sensor film 210 may be replaced by a staircase capacitance sensor (e.g., a 3D capacitance sensor) for detecting icing in the z direction, for example thickness.

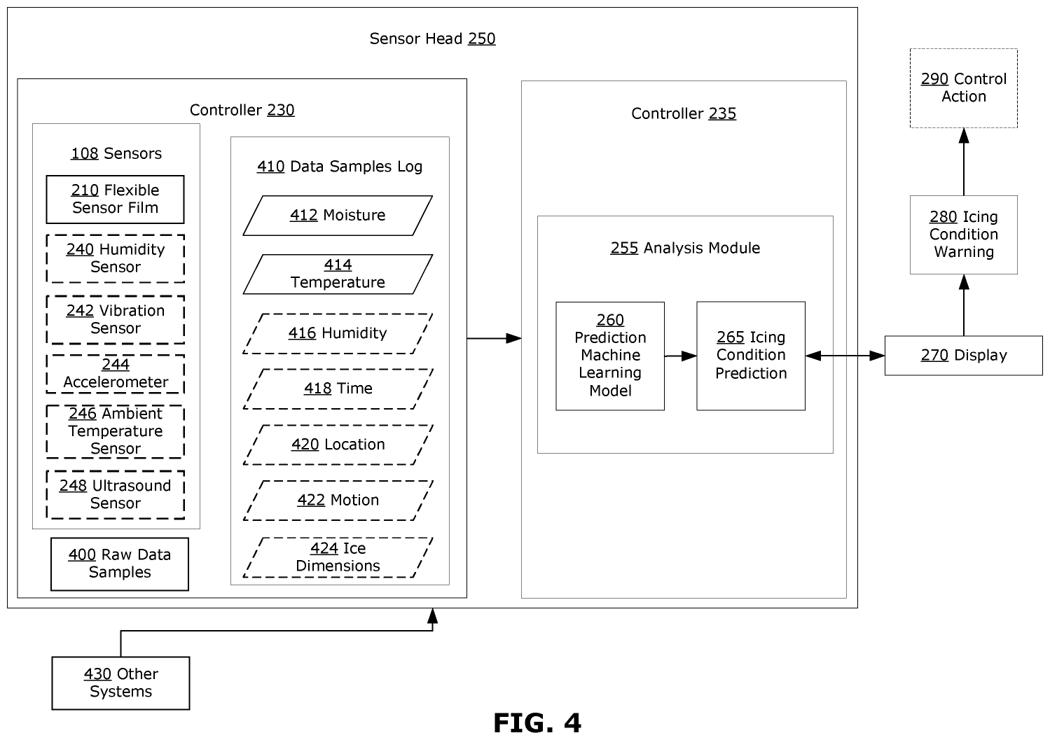

FIG. 4 shows a block diagram of an example sensor head 250 of the moisture and icing detection system 200 of the present disclosure, including controllers 230 and 235. In some implementations, different functions of the controllers 230 and 235 can be performed on different devices other than the computing system 100. For example, computationally intensive functions such as training machine learning models and executing trained machine learning models can be performed on a cloud computing platform in communication with a local computing system 100.

In examples, a controller 230 may operate the water sensor 215 and temperature sensor 220, or optionally a humidity sensor 240, a vibration sensor 242, an accelerometer 244, an ambient temperature sensor 246 or an ultrasound sensor 248 to obtain raw data samples 400. The raw data samples 400 may be obtained periodically, such as every second or minute or some other period or continuously. The controller 230 may record or save the raw data samples 400, including raw data samples from sensors 108 or components other than the water sensor 215 and temperature sensor 220, in memory 116. The raw data samples 400 may be recorded for a fixed period of time, for example 24 hours, a week, or until the memory 116 is full, and may record the raw data samples 400 only while certain conditions are met, such as when the aircraft is operating or when there is the potential for ice. The raw data samples 400 may be obtained at irregular intervals such as at the request of an operator or flight systems. The raw data samples 400 may be obtained all the time, only while the aircraft is operational or only while the aircraft is in circumstances where ice formation is a risk. The controller 230 may detect aircraft operation with a vibration sensor 242, accelerometer 244, or via communication with the aircraft flight systems.

The controller 230 may record sensor data and/or icing determinations along with time and location information to a data samples log 410, such as in digital memory. In examples, the log may include data samples of moisture 412, temperature 414, and optionally data samples of humidity 416, time 418, position 420, motion 422 or ice dimensions 424. The log 410 may be accessed by the operator or downloaded (such as to a personal computer, tablet, smart phone, cloud storage, or PED) for storage, diagnostic or analysis purposes, for example after a flight has finished, during a flight or in the event of an accident or near accident. Atmospheric information, such as the temperature 414 and humidity 416, from the log 410 may be accessible in real-time by other individuals or systems, such as a weather forecast system or operators of other aircraft during a flight. For example, the log 410 may be used to provide real-time atmospheric information for assessing/updating weather forecasts or for determining/updating flight routes of other aircraft within the vicinity. The log 410 may also be combined with the logs of other aircraft to obtain a more complete picture of atmospheric conditions across a specified region. The location 420 and/or time 318 information may be obtained from other systems 430, for example a GPS system, either as part of the moisture and icing detection system 200 or from other components on the aircraft.

The sensor head 250 and controllers 230 and 235 may operate only when the aircraft is operating. This may be done by being powered by the aircraft electrical system or receiving a signal that the aircraft is operating manually or automatically, or detecting aircraft operation with a vibration sensor 242 or accelerometer 244. When not operating, the sensor head 250 and other components may enter a low power or ‘sleep’ mode to conserve power, particularly if powered from batteries or solar panel.

In an embodiment, the moisture and icing detection system 200 may detect the presence of water on the sensing element of the sensor film 210 by measuring the capacitance of the element using two or more conductive electrodes in the sensor film 210. Without limitation to this theory, water has a higher relative dielectric constant (εr) than that of air. Capacitance may be measured by setting the two electrodes to opposite voltages, for example, one grounded and the other set to a supply voltage of the circuit, and then allowing a settling time for the voltages on the two electrodes to stabilize. Once stabilized, the settled voltage on each may be measured. This process of settling the voltage of the electrodes may be repeated with the initial voltages on each electrode swapped, for example, the one which was initially set to ground is now set to the power supply voltage, and the one that was initially set to the power supply voltage is set to ground. The sensor head 250 may use this process repeatedly to determine the capacitance of the sensor film and detect the water through an increased capacitance.

A controller 235 may process the raw data samples 400 to identify or predict potential icing conditions to generate an icing condition warning 280. The controller 235 may generate an icing condition warning 280 if the water sensor 215 indicates the presence of ice or water on the sensor film 210 and the temperature sensor 220 indicates temperatures less than the freezing temperature of water. The controller 235 may generate an icing condition warning 280 based on the change in temperature and/or the amount of water/ice detected by the water sensor 215. The controller 235 may generate different types of icing warnings such as one or more of that icing is possible, is starting to occur, there is minor icing, there is significant icing, and icing has already occurred. The controller 235 may generate informational data such as the presence of water and the temperature of the sensor.

In some examples, the controller 235 may include an analysis module 255 to determine whether icing conditions are present using one or more algorithms. In one embodiment, the analysis module 255 may use a lookup table to determine if icing is likely based on the temperature and water sensor.

In another embodiment, analysis module 255 may determine whether icing conditions are present using a prediction machine learning (ML) model 260. In some embodiments, the prediction ML model 260 is a trained ML model. The trained prediction ML model must be trained using machine learning algorithms before the analysis module 255 can generate an icing prediction 265.

In some embodiments, for example, the prediction ML model 260 is trained to predict an icing condition 265 using training data obtained for a surface positioned within an icing wind tunnel. In examples, training data may include historical icing condition information obtained from an icing wind tunnel and may comprise at least measured water sensor data samples, measured temperature sensor data samples and measured ice dimension data samples, among other icing condition data samples. A training dataset, consisting of historical icing condition information obtained from an icing wind tunnel can be used to train the prediction ML model 260 using any of a number of machine learning techniques, such as supervised, unsupervised, or semi-supervised learning techniques. It will be appreciated that other types of models, trained using machine learning techniques (also called “machine learning models”), can be used in some embodiments to implement the prediction ML model 260. In some embodiments, for example, the prediction ML model 260 may be a neural network. In some embodiments, for example, the prediction ML model 260 may be a classifier, for example, to generate icing condition predictions 265 corresponding to one or more classes, such as ice type, ice thickness, accretion etc.

In some embodiments, the training data used to train the prediction ML model 260 includes semantically labelled data samples, such as pre-processed samples of historical icing condition information, each data sample being labelled, for example, with a ground truth ice type value or a ground truth ice thickness value, or another ground truth value associated with the historical icing condition information.

In some embodiments, for example, training the prediction ML model 260 comprises inputting training data to the prediction ML model 260 to output the icing condition prediction 265 based on a measured water sensor data sample on the surface and a measured temperature sensor data sample on the surface. In some embodiments, for example, training the prediction ML model 260 using the ground truth icing condition values obtained from the training data, may minimize an error function. Once training terminates, the ML model 260 is considered to be a trained prediction ML model 260 and is ready to be executed within the moisture and icing detection system 200. In examples, the trained prediction ML model 260 may generate an icing condition prediction 265 after receiving an instruction from a user, for example, through a user interface of the display 270, or the trained prediction ML model 260 may automatically generate an icing condition prediction 265 at regular intervals, for example, every minute, every 5 minutes, every hour etc. In examples, the icing condition prediction 265 may be updated as new raw data samples from sensors 108 are received.

In examples, various adjustments may be made by controller 235 when interpreting the temperature and water sensor data, such as based on the ambient humidity and the installation situations. A humidity sensor 240 may be used to detect the relative humidity of the surrounding air. This humidity data may be used by controller 235 to differentiate between an elevated capacitance reading from the water sensor 215 due to high humidity as compared to water or ice on the sensor film 210. For example, capacitance reading values greater than that expected when exposed to air alone having the determined humidity may be indicative of water or ice on the sensor film 210. The humidity data may also be used, in combination with the temperature, by controller 235 to determine the presence or development of icing conditions prior to an actual buildup of ice, such as despite a lack of water/ice detected by the water sensor 215. For example, the controller 235 may generate an icing condition warning 280 if the humidity sensor 240 indicates high ambient humidity and the temperature sensor 20 indicates temperatures less than the freezing temperature of water. The humidity sensor 240 may be located where it can adequately sense the ambient humidity and the results communicated to the controller 235.

In examples, an adjustment to the algorithm may be made based on the installation of the water sensor 215 and temperature sensor 220. For example, whether the sensor film 210 is mounted on aluminum surface or a fibreglass surface may result in different water or temperature sensor data. A suitable adjustment may be made by the controller 235 to the raw sensor data such as to reflect the material of the installation surface and paint, either between the surface and the flexible sensor film or on top of the flexible sensor film. This adjustment may be made manually, such as at the time of installation, or automatically during an initiation or start up step.

Optionally, the moisture and icing detection system 200 may further include a second temperature sensor (e.g. an ambient temperature sensor 246) that can detect the ambient temperature. The ambient temperature data may be stored in the data samples log 410 and used by controller 235 to assist in determining whether the aircraft is in icing conditions. For example, if the aircraft descends from an altitude where the ambient temperature is below zero to an altitude where the ambient temperature is above zero as detected by the ambient temperature sensor 246, the surface of the aircraft and the sensor film 210 may still have a temperature below zero for a period of time as detected by the temperature sensor 220. Accordingly, the ambient temperature data may help provide a determination that the aircraft is no longer in icing conditions, although it may still be temporarily susceptible to icing. The ambient temperature sensor 246 may be located where it can adequately sense the ambient temperature and communicate the results to the controller 235.

In some embodiments, for example, controller 235 may be the same or different from controller 230 and some or all of the functionality of one controller may be performed by the second controller or vice versa. A single controller may be used or more than two controllers may be used. A suitable communication link, wired or wireless, may be used to connect the controllers and data, such as the temperature and presence of water. Controller 230 may be in sensor head 250. Controller 235 may be in sensor head 250 or in any other suitable component of the system.

The sensor head 250 may contain a power source such as batteries, solar panels or another power source. The sensor head 250 may be connected to the aircraft electrical system by a cable 258 and be powered by the aircraft systems. It may operate while the aircraft is operational and providing it power. Particularly if the sensor head 250 is powered by batteries or other low power sources, it may use minimal power to operate the sensor film and generate icing condition warnings 280 to preserve power.

The sensor head 250 may communicate with indicators inside the aircraft to provide icing warnings and moisture/temperature information. The sensor head 250 may communicate using the aircraft electrical system. The sensor head 250 may communicate wirelessly such as using short range wireless protocols such as RF, IR, Bluetooth, Wi-Fi or other wireless systems. Using wireless communications may be advantageous if installing the sensor head 250 on the exterior of an existing aircraft as it may not require holes in the flight surface of the aircraft. Controller 235 may be in a separate component from the sensor head 250 and determine the presence of ice or water based on sensor information communicated wirelessly or wired from the sensor head 250. Controller 235 may communicate and receive sensor information from more than one sensor head 250. The controller 235 may be connected to and powered by the aircraft electrical system. A determination of icing may be communicated periodically or continuously, or only when icing conditions exist, or in response to a request from other systems.

Whether wireless (such as RF, IF, Bluetooth, Wi-Fi or other wireless protocols) or wired communication is used, a suitable wireless receiver, which may be a receiver or transceiver, may be mounted within the aircraft to obtain communications from the sensor head 250 and/or controller 235. The receiver may be integrated with, or in communication with the controller 235. The receiver, such as the controller 235, may be connected to the electrical system of the aircraft such as the aircraft's onboard systems, to receive any icing warnings or moisture/temperature information from the sensor head 250. Icing warnings may result in visual (such as an indicator on a LCD display, or a warning flashing light) or audio indicators (such as a buzzer sounding) or vibrational (haptic) indication to be provided to an operator (for example pilot or drone operator) of the aircraft. The receiver may be positioned within the cockpit of the aircraft to provide an indication of icing warnings, such as by operating a light or audio signal. The receiver may relay this information to a ground station. The receiver may be on the ground, such as if the aircraft is an unmanned aircraft.

In some embodiments, for example, a display 270 may indicate information or an icing condition warning 280 if ice is detected. The display 270 may include other information such as the type or amount (e.g. ice dimensions, thickness) of ice, presence of water, humidity and/or temperature. The display may indicate the status of the system such as the operating status of the sensors 108, de-icing heaters within a de-icing system, sensor heads 250, sensor films 10 and if the components of the moisture and icing detection system 200 are in communication for one or more sensor heads 250 on the aircraft. The display 270 may be specific for the de-icing system or a more general display used for other aspects of the aircraft control. For example, the display 270 may be a general purpose display integrated with the instrument panel for a human operator of an aircraft in the cockpit a manned aircraft or for a drone operator on the ground. The display may be connected to the aircraft electrical system or have an independent power source such as batteries or solar panels. The display may be on a personal electronic device (PED) such as smartphone, tablet, personal computer or smartwatch, among others.

In some embodiments, for example, an icing condition warning 280 may result in the moisture and icing detection system 200 executing a control action 290, for example, operating some functionality of a de-icing system either automatically or in response to manual intervention of an operator. In examples, the control action 290 applied to the de-icing system may include starting or stopping the de-icing system. In some examples, the de-icing system may be a chemical de-icing system, and a control action 290 may include starting or stopping the flow of a de-icing fluid emitted on to one or more flight surfaces. In examples, a de-icing fluid may be sprayed on to a flight surface, or may travel along a channel, among others. In some examples, the de-icing system may be a an electrical de-icing system, and the control action 290 may include turning on or turning off power applied to de-icing thermoelectric elements, or varying the input voltage or current applied to de-icing thermoelectric elements, for example, increasing or decreasing the input. In some examples, the de-icing system may be a mechanical de-icing system, and the control action 290 may include ice removal by mechanical means, for example, using wipers or scrapers, vibration, etc.

In some embodiments, an icing condition warning 280 may cause the aircraft to take a control action 290 as a flight action, such as reducing altitude to warmer air either automatically, particularly if the aircraft is unmanned, or with manual intervention of an operator. An icing condition warning 280 may be communicated to a flight control system, such as an autopilot, and used to make operation decisions. The operational decision may include changing or reversing course, or changing altitude.

In some examples, the trained prediction ML model 260 may trigger a control action 290, such as one of the control actions described above for mitigating an icing condition, in response to generating an icing condition prediction 265. In some examples, the prediction ML model 260 is trained to predict likely icing conditions ahead of time based on patterns that statistically tend to result in icing conditions: some such embodiments may be able to predict likely icing conditions before ice actually begins forming, and may trigger a control action 290 to pre-emptively prevent the formation of ice on the surface, for example by pre-emptively spraying de-icing fluid or activating de-icing thermoelectric elements. For example, the trained prediction ML model 260 may be able to prospectively predict the likely formation of ice based on a low surface temperature detected by the temperature sensor 200 simultaneously with a change from low air temperature to high air temperature detected by the ambient temperature sensor 246, which is often followed by condensation of moisture on the surface. In non-aircraft contexts, a prediction ML model 260 could be used to predict and respond to icing events such as icing conditions on automobile tire surfaces or road surfaces, and to trigger warning and/or control actions of a ground-based vehicle appropriately (for example, by presenting a warning to an operator of a ground based vehicle, by pre-emptively braking a ground-based vehicle when traveling at certain speeds under icing conditions, etc.).

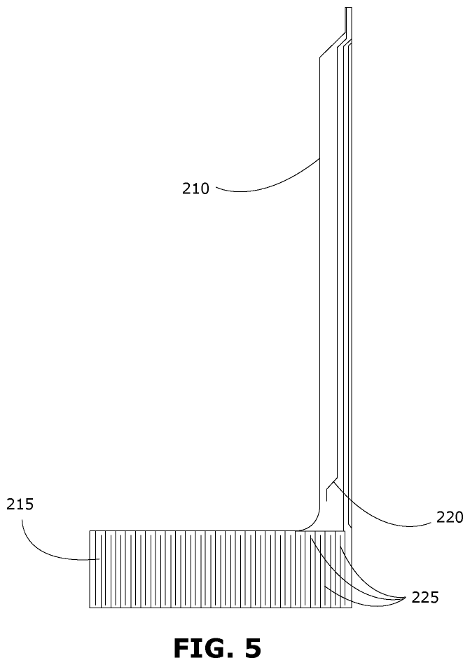

FIG. 5 is a top view of a sensor film 210, comprising a water sensor 215 and a temperature sensor 220 and de-icing heating elements 225, in accordance with examples of the present disclosure in accordance with example implementations described herein. In some examples, the de-icing heating elements 225 may interface with a de-icing system of an aircraft.

In an example embodiment, de-icing heating elements 225 may be integrated with sensor film 210. The de-icing heating elements 225 may be integrated with sensor film 210 such that the electrical terminals of the water sensor also form the heating elements 225 of the de-icing system. De-icing heating elements 225 may be electrically powered from the sensor head 250 to melt any ice that has accumulated on the surface. The de-icing heating elements 225 may be activated automatically when ice conditions are detected or manually activated, for example, in response to an icing condition warning 280 generated by the moisture and icing detection system 200.

In some embodiments, for example, sensor film 210 may include one or more filaments, wires, webs to connect to the sensor head 250. De-icing heating elements 225 may be proximate, interleaved or combined with one or more water sensors 215. A temperature sensor 220 may be placed on the sensor film 210 away from the de-icing heating element 225 so that potential interference between the heating element 225 and the temperature sensor 220 is reduced. The sensor film 210 may be shaped to cooperate with a flight surface to provide icing condition warnings 280 over a portion, or a substantial portion of the surface. Similarly, if the sensor film 210 includes de-icing heating elements 225, the heating elements 225 may provide de-icing over a substantial portion of the surface.

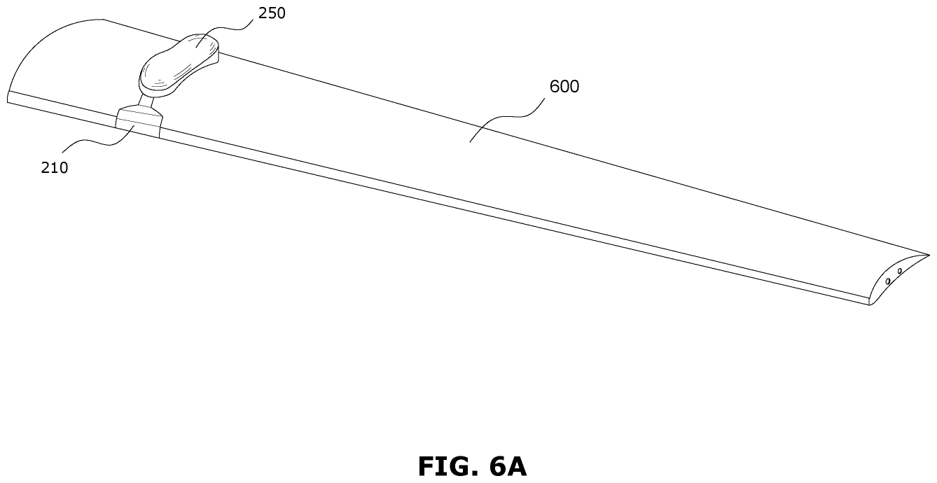

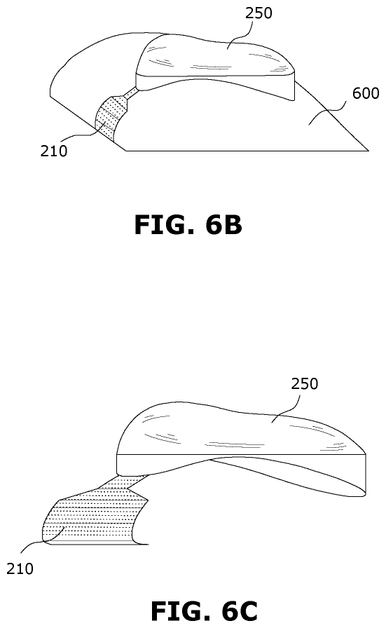

FIGS. 6A-6C illustrate an example embodiment of a sensor film 210 configured on a flight surface of a rotor 600, in accordance with example implementations described herein. FIG. 6A is a perspective view of the example embodiment, where the sensor film 210 is applied over a curved edge of the rotor 600 In examples, the sensor film 210 is thin and flexible to enable the application of the sensor film 210 around the leading edge of the rotor 600. In examples, the sensor head 250 may be affixed to the exterior of the aircraft in a similar manner as the sensor film 210, with the sensor head 250 positioned on a top surface of the rotor 600.

FIG. 6B is another perspective view of the example embodiment of FIG. 6A, in accordance with example implementations described herein. As shown in FIG. 6B,e the sensor film 210 is wrapped around a curved edge of the rotor 600, and the sensor head 250 is mounted on a top surface of the rotor 600. FIG. 6C is cut-away perspective view of the example embodiment of FIG. 6A, in accordance with example implementations described herein. As shown in FIG. 6C, the surface of the rotor 600 has been removed from the view to further illustrate the curvature of the sensor film 210 around the curved edge of the rotor 600.

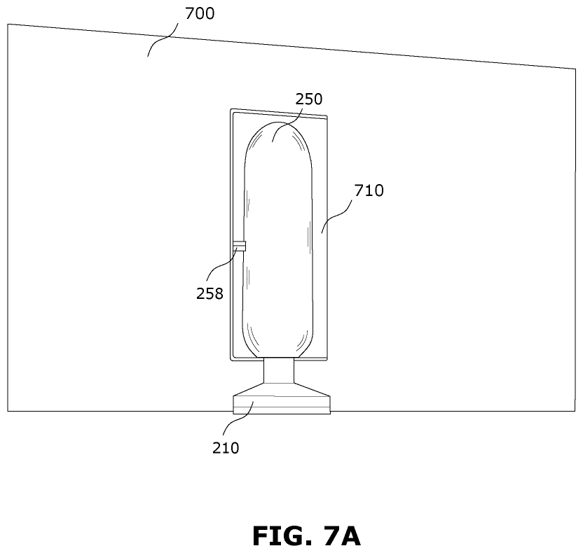

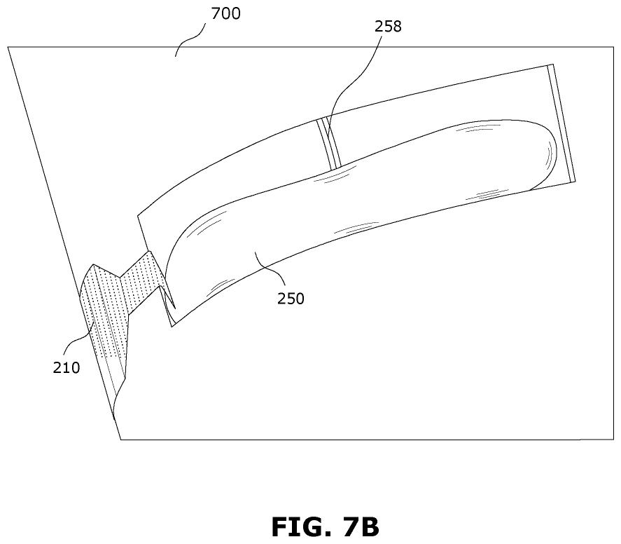

FIG. 7A is a top view of an example embodiment of a sensor film 210 configured on a flight surface 700, for example, a wing or a propeller blade of an aircraft, and where the sensor head 250 is interior to the flight surface, in accordance with examples of the present disclosure. As described in previous examples, the sensor film 210 may be applied over a curved edge of the flight surface 700, for example, the leading edge of an aircraft wing or propeller blade. In examples, the sensor head 250 is positioned within an open space or a recess 710 of the wing, with a suitable hole or electrical conductor 258 to allow the electrical communication between the sensor film 210 and the sensor head 250. In other embodiments, for example, the sensor film 210 and sensor head 250 may communicate wirelessly, for example using RFID tags in the sensor film 210 and a reader housed within the sensor head 250, or using RF circuits such as UHF passive RFID. In other embodiments, for example, the sensor head 250 may be integrated with the aircraft, such as implanted into a propeller blade during manufacturing of the propeller blade. FIG. 7B is a perspective view of the example embodiment of FIG. 7A.

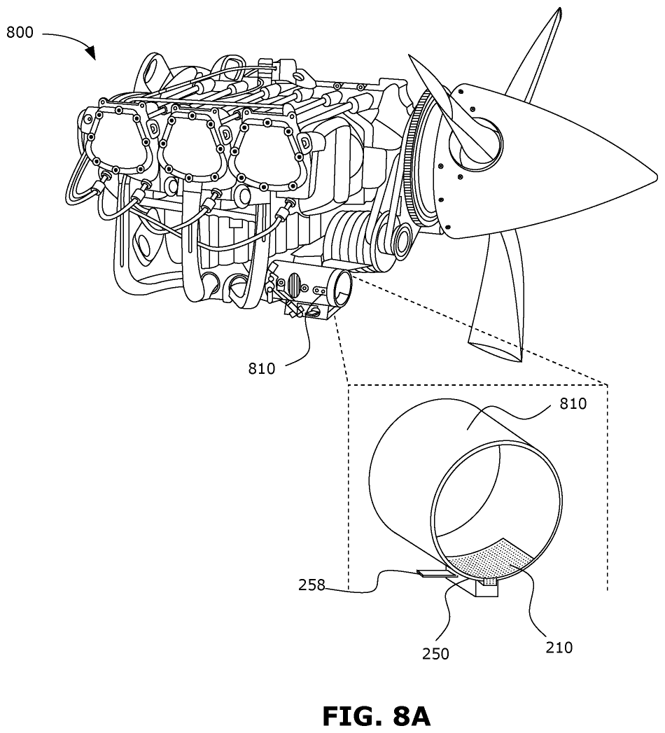

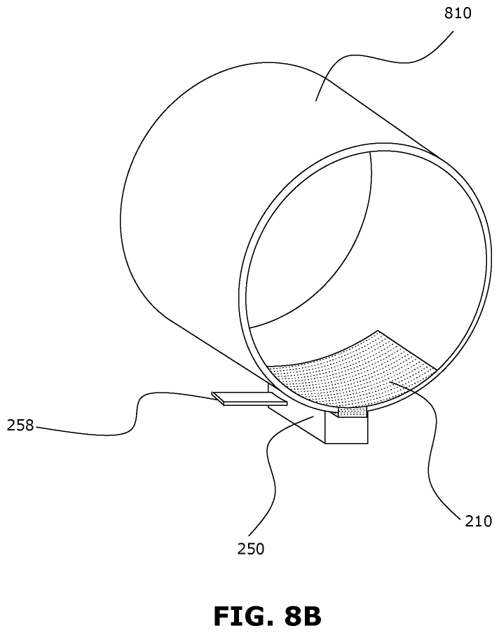

FIG. 8A is an example embodiment of a sensor film 210 configured on a flight surface, where the sensor film 210 is installed on a leading edge of an engine air intake 810, in accordance with examples of the present disclosure. In examples, an engine air intake 810 is a component of an aircraft engine 800 that brings air from outside the aircraft into the engine 800 to be mixed with fuel. In examples, the sensor film 210 is applied over a curved edge of the engine air intake 810 and the sensor head 250 may be affixed to the exterior of the aircraft in a similar manner as the sensor film 210, with the sensor head 250 positioned on a bottom surface of the engine air intake 810. In examples, an electrical conductor 258 enables electrical communication between the sensor head 250 and a power source (such as the aircraft electrical system) and/or additional components (e.g., by acting as a conduit for the IO interface 104 and/or network interface 114). FIG. 8B is a magnified perspective view of the engine air intake 810 of the example embodiment of FIG. 8A.

Example implementations of methods for moisture and icing detection will now be described, with reference to the moisture and icing detection system 200.

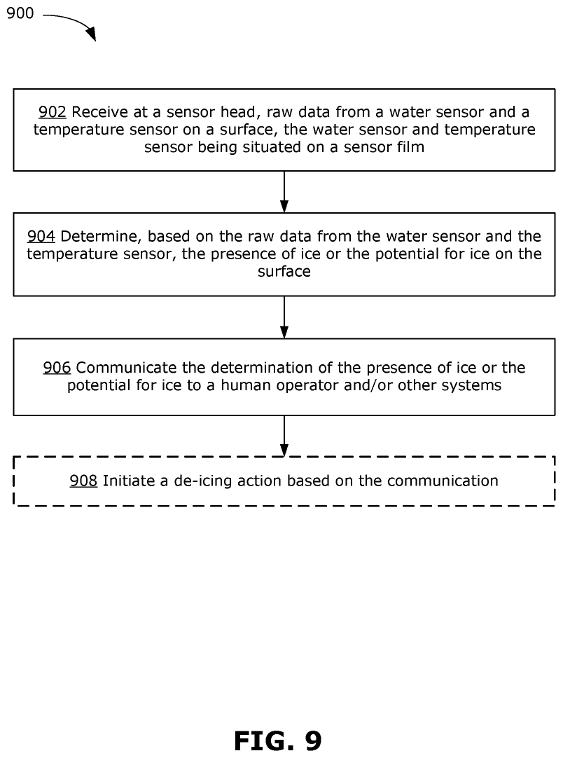

FIG. 9 is a flowchart illustrating an example method 900 for generating icing condition warnings, in accordance with examples of the present disclosure. The method 900 may be performed by the computing system 100. For example, the processor 102 may execute computer readable instructions 200-I (which can be stored in the memory 116) to cause the computing system 100 to perform the method 900.

The method 900 begins at step 902, in which raw data from a water sensor 215 and a temperature sensor 220 on a surface are received at a sensor head 250. In examples, the water sensor 215 and temperature sensor 220 may be situated on a sensor film 210 coupled to the surface.

At step 904, the presence of ice or the potential for ice on the surface may be determined, based on the raw data from the water sensor 215 and the temperature sensor 220.

At step 906, the determination of the presence of ice or the potential for ice may be communicated to a human operator and/or other systems. In some examples, the determination of the presence of ice or the potential for ice may be communicated in the form of an icing condition warning 280 on a display 270.

Optionally, at step 908, a control action 290 in the form of a de-icing action may be initiated based on the communication.

The present disclosure provides the technical advantage that the moisture and icing detection system may be suitable for installing on existing aircraft, such as an after-market system. By being affixed to the exterior of the aircraft surface, being of low weight, and being self-contained with its own power supply, modifications to the aircraft may be minimized.

The present disclosure provides the technical advantage that the moisture and icing detection system may be particularly suitable for installing on smaller manned aircraft or unmanned aircraft, such as drones, which may be of smaller size than manned aircraft. By being of low weight and having low power requirements, it may provide minimal interference with the flight characteristics of the aircraft. For unmanned aircraft, particularly autonomous or semi-autonomous, the icing information may be communicated to the flight control system, such as over wireless connection. The wireless connection may be exclusively for icing information or more preferably may utilize a communication link used for other flight control information.

While described primarily in the context of a flight surface for an aircraft, various non-aircraft or internet of things (IoT) applications may benefit from some or all aspects of the present disclosure. Some examples of non-aircraft applications include: wind turbines; solar panels; any outdoor structure requiring weather stations (e.g., cell towers, power lines, bridges); weather monitoring (e.g., multiple individual stations at multiple locations aggregated to form a network of weather monitoring stations). Some examples of IoT applications include: aggregate monitoring networks (e.g., network of weather sensors to assemble complex, geographically diverse data); drone fleets (e.g., a fleet of drones or other aircraft for collecting regional weather data at specified locations or altitudes); ground-based infrastructure (e.g., buildings, bridges, towers etc.); or other equipment or devices that may be regionally distributed to acquire data (including a time stamp and geotag for data aggregation).

Various embodiments of the present disclosure having been thus described in detail by way of example, it will be apparent to those skilled in the art that variations and modifications may be made without departing from the disclosure. The disclosure includes all such variations and modifications as fall within the scope of the appended claims.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. An icing warning system for a structure with an exterior surface comprising:
a water sensor applicable to the exterior surface, the water sensor comprising an electronic capacitive detector for measuring water on the exterior surface;
a sensor head in communication with the water sensor that receives raw data from the water sensor; and
a controller in communication with the sensor head to receive the raw data from the sensor head, the controller being configured to receive a temperature measurement and to generate an icing warning responsive to:
the raw data received from the sensor head indicating the presence of water or ice on the exterior surface; and
the temperature measurement indicating a temperature less than a freezing temperature of water.

2. The icing warning system of claim 1, further comprising:
a temperature sensor for measuring the exterior surface temperature, wherein the sensor head is in communication with the temperature sensor and further receives raw data from the temperature sensor, and wherein the controller receives the temperature measurement in the raw data from the sensor head.

3. The icing warning system of claim 1, further comprising:
a humidity sensor for measuring relative humidity, wherein the sensor head is in communication with the humidity sensor and further receives raw data from the humidity sensor, and the controller is further configured to generate the icing warning based on the humidity data received in the raw data from the sensor head.

4. The icing warning system of claim 1, further comprising:
an ultrasonic sensor for obtaining ultrasound data, wherein the sensor head is in communication with the ultrasonic sensor and further receives raw data from the ultrasonic sensor, and the controller is further configured to generate the icing warning based on the ultrasound data received in the raw data from the sensor head.

5. The icing warning system of claim 1 where the exterior surface is a flight surface of a manned or unmanned aircraft.

6. The icing warning system of claim 1, wherein the exterior surface is a propeller of the manned or unmanned aircraft.

7. The icing warning system of claim 1 wherein the exterior surface is an air intake for an engine of the manned or unmanned aircraft.

8. The icing warning system of claim 1 wherein the temperature measurement is a measurement of an exterior surface temperature proximate to the exterior surface.

9. The icing warning system of claim 1 wherein the controller is contained within the sensor head.

10. The icing warning system of claim 1 further comprising a communication link between the controller and an operator warning system, wherein the generated icing warning is communicated to the operator warning system.

11. The icing warning system of claim 1 wherein the controller is configured to process the raw data received from the sensor head to generate informational data indicating water presence.

12. The icing warning system of claim 1, wherein the controller is further configured to communicate the icing warning to a human operator and/or other systems.

13. The icing warning system of claim 1, further comprising a de-icing system, wherein the icing warning is communicated to the de-icing system to cause the de-icing system to initiate a de-icing action.

14. The icing warning system of claim 1, wherein the sensor head is in wireless communication with the water sensor.

15. The icing warning system of claim 14, further comprising a flexible sensor film for application to the exterior surface, the flexible sensor film comprising the water sensor, wherein the flexible sensor film includes a radiofrequency identification (RFID) tag and the sensor head includes a RF reader, to enable the wireless communication.

16. The icing warning system of claim 1 where the exterior surface is an exterior surface of an ingress protection (IP) rated enclosure.

17. The icing warning system of claim 3, wherein the controller is further configured to compute an installation adjustment, and the controller is further configured to generate the icing warning also based on the installation adjustment.

18. The icing warning system of claim 1, wherein the water sensor comprises two or more electrical terminals, the raw data received from the sensor head includes a measure of capacitance between the at least two or more electrical terminals, and the controller is configured to generate the icing warning based on the measure of capacitance between the at least two or more electrical terminals.

19. The icing warning system of claim 1, wherein the raw data received from the sensor head indicates the presence of water based on a lookup table using the raw data from the sensor head and the temperature measurement.

20. The icing warning system of claim 1, wherein the raw data received from the sensor head indicates the presence of water based on a trained machine learning (ML) model using the raw data from the sensor head and the temperature measurement.

21-30. (canceled)
